(19) United States
(12) Patent Application Publication
(10) Pub. No.: US 2016/0047966 A1
(43) Pub. Date: Feb. 18, 2016

(54) Electrical household appliance having an illuminated interior

(71) Applicant: EMZ-HANAUER GMBH & CO. KGAA, Nabburg (DE)

(72) Inventors: Johann Schenkl, Bodenwoehr (DE); Manfredi Signorino, Milano (IT); Martin Brabec, Nabburg (DE)

(73) Assignee: EMZ-HANAUER GMBH & CO. KGAA, Nabburg (DE)

(21) Appl. No.: 14/782,870

(22) PCT Filed: Mar. 11, 2014
(86) PCT No.: PCT/EP2014/054678

§ 371 Date: Oct. 7, 2015

(30) Foreign Application Priority Data
Apr. 8, 2013 (DE) 10 2013 005 988.7

(51) Int. Cl. F21V 8/00; F25D 27/00

(52) U.S. Cl. CPC G02B 6/003; G02B 6/0031; G02B 6/0038; G02B 6/0073; G02B 6/0068; F25D 27/00

(57) ABSTRACT

The invention relates to an electrical household appliance, namely a refrigeration and/or freezer device or a stove, comprising at least one luminous plate (24) illuminating an interior of the appliance, and a light source device (30) feeding light into at least one narrow side of the luminous plate. According to the invention, the light source device includes at least one light-emitting diode (32) and a lens optics, which collects at least a major portion of the light emitted by the light-emitting diode, directing the light to at least one narrow side of the luminous plate.

The present invention relates to an electrical household appliance having an illuminated interior which can be used for keeping or temporarily storing foodstuffs or other products for daily domestic use. A refrigerator, freezing appliance, wine-cooler, stove or microwave oven is an example of such a household appliance.

In order to be able to see dearly the products stowed in the interior, it is expedient to provide an illuminating device by which said interior can be lit up. Recently, light-emitting diodes have been proposed, inter as light sources for such illuminating devices. In some variants of these, the light generated by the light-emitting diodes is fed, on the narrow side, into, for instance, plates, for example glass plates, which are used for depositing the products to be stowed, and the plates which are lit in this way are used to illuminate the interior of the appliance in the most homogeneous manner possible. Examples of such illuminating devices are described in the following published specifications: WO 2010/023086 A1, WO 2007/049935 A2 and U.S. Pat. No. 7,201,487 B2.

By contrast, the invention proposes an electrical household appliance, namely a refrigerating and/or freezing appliance or stove, comprising at least one luminous plate which illuminates an interior of the appliance and a light source device which feeds light into the luminous plate at least on a first narrow side of the latter. According to the invention, the light source device includes at least one light-emitting diode and lens optics which collect at least a major portion of the light radiated by the light-emitting diode and direct it onto the first narrow side of the luminous plate.

A light source device of this kind is distinguished, in particular, by high efficiency and feeds the major portion of the light emitted by the light-emitting diode into the luminous plate. By the arranging of lens optics in the light path between the light-emitting diode and a narrow side of the luminous plate, the light radiated by said light-emitting diode is first of all collected, and is preferably even collimated, before it enters the luminous plate on the narrow side of the latter. As a result, a far greater portion of the light emitted by the light-emitting diode is fed into the luminous plate than would be the case if the light from the light-emitting diode were fed directly into said luminous plate without using lens optics. The light emitted is therefore used more effectively, lights up the luminous plate more brightly and, finally, permits more homogeneous illumination of the interior.

Under these circumstances, the luminous plate may be manufactured from an at least partially transparent material, and may preferably be designed as a transparent glass plate. In this case, the luminous plate may be arranged in the interior of the appliance and serve, for example, for depositing the products to be stowed. It is also conceivably possible to arrange the luminous plate behind a wall that delimits the interior of the appliance or in an access door to said interior, in which case the wall or access door is at least partially light-permeable, such as is the situation, for instance, in the case of a perforated microwave lattice or a transparent oven door glass. The lens optics may be realised by an individual lens or by a plurality of lenses located one behind another. If the light source device comprises a plurality of light-emitting diodes, lens optics having an individual lens in each case, or a plurality of lenses located one behind another, may likewise be made available in association with each of the light-emitting diodes.

In one preferred configuration, the lens optics under consideration collimate, when viewed in a sectional plane orthogonal to the longitudinal extension of the first narrow side, the light of the at least one light-emitting diode that passes to said lens optics, in which case light-dispersing structures are formed in the luminous plate, at a distance from its outer flat sides, in different planes along the thickness of said luminous plate.

Provision may preferably be made for the lens optics to be seated, at least partially but preferably even completely, in a recessed manner in a reflector cavity, the aperture of which faces towards the first narrow side of the luminous plate and the walls of which form a reflective surface for light from the light-emitting diode. In this case, said light-emitting diode can be accommodated in the region of the bottom of the reflector cavity. If the emission angle of the light-emitting diode is sufficiently large for a portion of the light emitted by the light-emitting diode to be radiated past the lens optics, the light emitted by the light-emitting diode is, in this way, kept within the space of the reflector cavity. Light which, from the light-emitting diode, first of all impinges upon a wall of the cavity, is reflected at that point and thus kept within the space of the reflector cavity before it either finally impinges upon the lens optics or is radiated past said lens optics towards the first narrow side of the luminous plate.

Provision may also be made for the lens optics—or at least part thereof—to be constructed in one piece with a light-guide body which is arranged between a bottom of the reflector cavity and said lens optics. It is preferable if said light-guide body fills up, substantially completely, the region of the reflector cavity between the bottom of said cavity and the lens optics. In this case, the light radiated by the light-emitting diode is first of all fed into the light-guide body. Light radiated towards the was of the cavity is then reflected, substantially by total reflection, on the surfaces of the light-guide body—instead of on the walls of the cavity—and is kept inside said light-guide body, before it finally passes out of the light-guide body towards the first narrow side of the luminous plate, if applicable through the lens optics which are constructed in one piece with said light-guide body. This variant is suitable, design-wise, particularly in the case of luminous plates of comparatively large thickness. In this case, the light-guide body may be designed, for instance, as a transparent, solid moulded part.

According to one preferred configuration, the lens optics may comprise a lens which fills up, substantially completely, the region between opposite sides of the cavity, at a distance from the bottom of said cavity. In an arrangement of this kind, substantially the whole of the light radiated by the light-emitting diode impinges upon the lens in order to be collected by the latter and directed towards the first narrow side of the luminous plate. Virtually no light gets past the lens without being collected, as a result of which a still greater portion of the light radiated by the light-emitting diode is fed into the luminous plate. The efficiency is increased accordingly.

An arrangement in which the reflector cavity is closed by the first narrow side of the luminous plate is particularly expedient. This ensures that the whole of the light guided within the reflector cavity is fed into the luminous plate and no light is radiated past said luminous plate. In this case, the reflector cavity may possess a dear aperture width which is no larger than the thickness of the luminous plate on the narrow side and preferably corresponds, at least approximately, to the said thickness of the plate. The efficiency is further increased in these cases.

As regards the configuration of the reflector cavity, this may be designed, lengthwise, in a trench or trough-like manner within the longitudinal extension of the first narrow side and, in this case, the lens optics may comprise a rod lens which is elongated in the trench longitudinal direction. The use of a rod lens arranged in this way is particularly advantageous because it collects the light emitted by the light-emitting diode merely orthogonally to the trench longitudinal direction but not in said longitudinal direction. There is therefore imparted to the light-projecting surface on the first narrow side of the luminous plate, which surface is generated by a single lights emitting diode, an oval shape of a kind that makes it possible—when using a plurality of light-emitting diodes which are arranged one behind another in the trench longitudinal direction—to make the distances between two adjacent light-emitting diodes relatively great without being obliged, in the process, to accept losses with respect to an approximately uniform distribution of light intensity on the first narrow side of the luminous plate. As a result, the light source device is able to manage, design-wise, with a comparatively small number of light-emitting diodes. In addition, a comparatively low structural shape of said light source device is made possible. If use is made of a light-guide body which is constructed in one piece with the rod lens, said body may be designed, for example, as a solid, elongated moulded part or continuously cast part.

If the light source device has a plurality of light-emitting diodes arranged one behind another in the trench longitudinal direction, it may be advantageous if the bottom of the reflector cavity has an undulatory profile in said trench longitudinal direction. In this case, troughs of the undulations are further away from the first narrow side of the luminous plate than are peaks of the undulations. Under these circumstances, the light-emitting diodes may each be arranged in the region of the troughs of the undulations. An undulatory profile of this kind helps to guide the light radiated by the light emitting diodes onto the lens optics, or the first narrow side of the luminous plate respectively, in the most evenly distributed manner possible, intensity-wise.

Basically, it is conceivably possible to not only provide one of the above-described light source devices on the first narrow side of the luminous plate, but to also provide a further light source device on a second narrow side of the latter, which side lies opposite said first narrow side of the luminous plate, in order to thereby achieve the most uniform light distribution possible within the luminous plate as a whole. In another configuration, on the other hand, it is conceivable for only one of two opposed narrow sides of the luminous plate to serve for feeding light in by means of the light source device, and for the other narrow side to be constructed merely for reflecting light which is guided within said luminous plate. A narrow side which is merely reflective can be realised, for example, by the application of an aluminium film in a laminar manner on said narrow side. Under these circumstances, the light reflected back by said film is collected again by the lens optics arranged in the reflector cavity and fed into the luminous plate again.

Through the fact that the light emitted by the light-emitting diode is collected or collimated first, before it enters the luminous plate, a large portion of the light rays fed into said luminous plate has a direction of propagation which is parallel, or virtually parallel, to the flat sides of the luminous plate. In the case of a direction of propagation of the light rays which is not completely parallel, total reflection may also occur because of a very shallow angle when internal impingement upon the flat sides of the luminous plate takes place. A large portion of the light fed in therefore initially remains within said luminous plate.

In order to control the passage of light out of the luminous plate and into the interior of the household appliance in a targeted manner, provision may be made, according to another form of embodiment of the invention, for forming one or more light-dispensing structures in the luminous plate at a distance from its outer flat sides. Light-dispersing structures form, so to speak, points of disruption in the luminous plate at which the light is dispersed, in particular dispersed in a diffuse manner. In contrast to light-dispersing structures which are formed directly on the outer surface of the luminous plate, the arranging of light-dispersing structures on the inside of said luminous plate avoids the creation of a sensitive luminous plate surface which is susceptible, for example, to scratching, contamination or even the use of chemicals. This is particularly advantageous against the background of the fact that, in addition to its illuminating function, the luminous plate is also used, under certain circumstances, for depositing the products which are to be stowed in the interior of the appliance.

If the luminous plate is formed from a single plate element, for instance from a simple glass plate, one or more light-dispersing structures may be formed within the depth of the material of the plate. Light-dispersing structures of this kind may, for example, be produced by three-dimensional laser engraving.

It is also conceivably possible for the luminous plate to be formed by a pair of plate elements which are arranged one on top of the other, and for one or more light-dispensing structures to be formed on at least one of the two flat sides, which face towards one another, of the plate elements. In this case, light-dispersing structures may be produced on the outside of the individual flat sides of the plate elements, for instance by scribing, milling, printing, embossing or engraving, in particular laser engraving. Through the fact that the flat sides in question, which face towards one another, of the plate elements are located on the inside of the luminous plate thus formed, the outer sides of said luminous plate still remain durable

In order to achieve the most homogeneous possible distribution as regards the light passing out of the luminous plate, light-dispersing structures may be arranged in a manner distributed over at least a large portion of said luminous plate. For this purpose, the luminous plate may have, for instance, light-dispersing structures in the form of a pattern of points and/or one or more light-dispersing structures in the form of a pattern of lines. In order to still further improve the distribution of the light, provision may also be made for the light-dispersing structures to be formed in different planes along the thickness of the luminous plate. It is also conceivable to provide light-dispersing structures in the form of motifs, for instance logos or characters which, for the observer, stand out conspicuously on the luminous plate.

The invention will be further explained below with the aid of the appended drawings, in which:

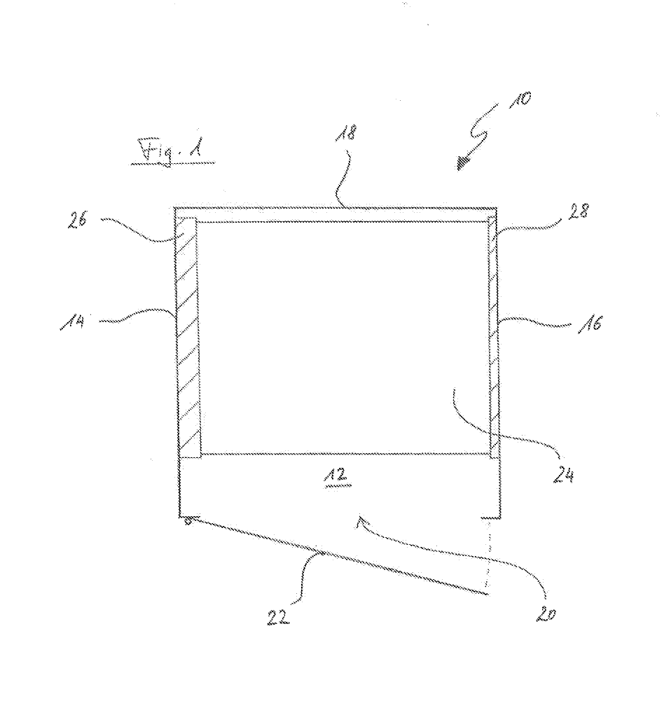

FIG. 1 represents, diagrammatically, an electrical household appliance according to one example of embodiment, in a sectional view;

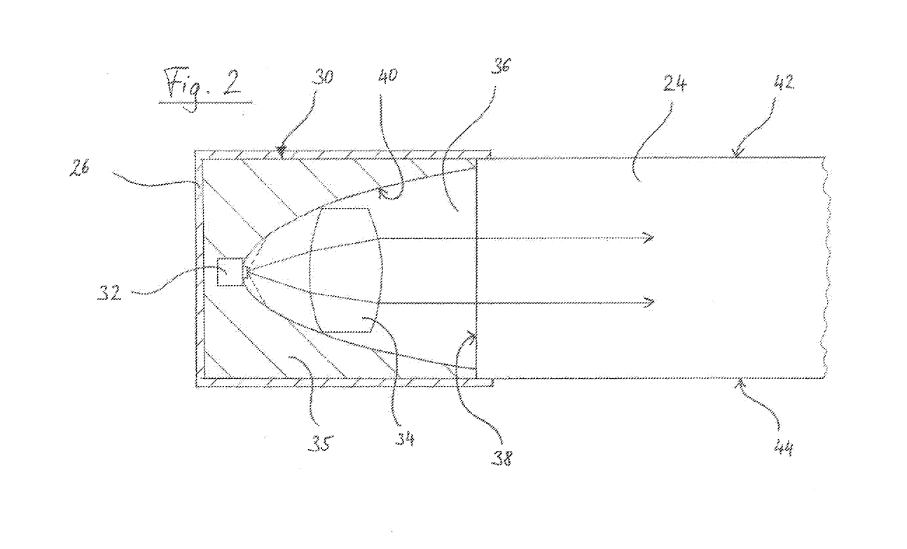

FIG. 2 represents the luminous plate from FIG. 1 with a light source device, in an enlarged sectional view which is orthogonal to FIG. 1;

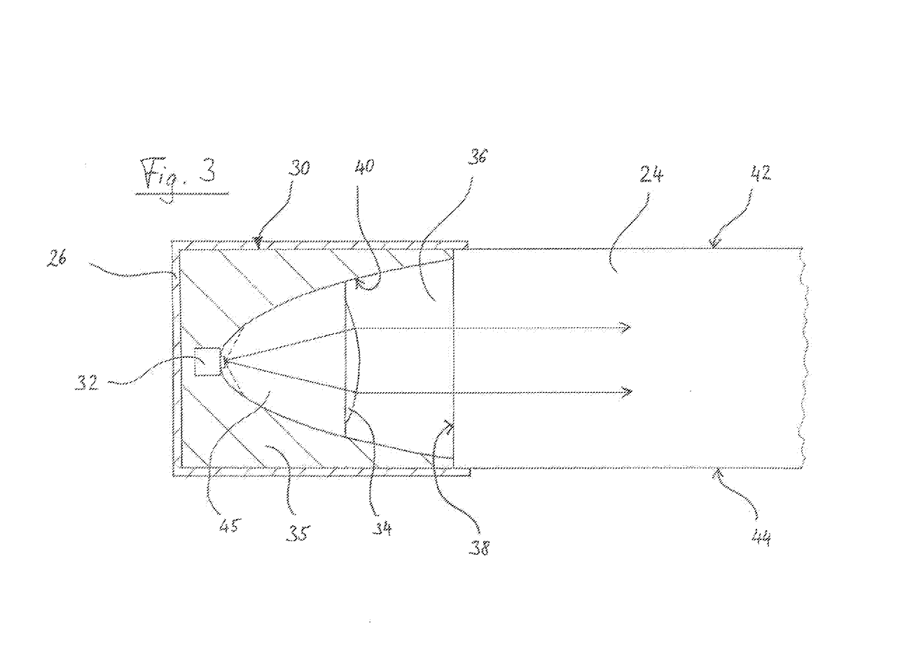

FIG. 3 represents a variant of FIG. 2 with a light-guide body which is constructed in one piece with a lens;

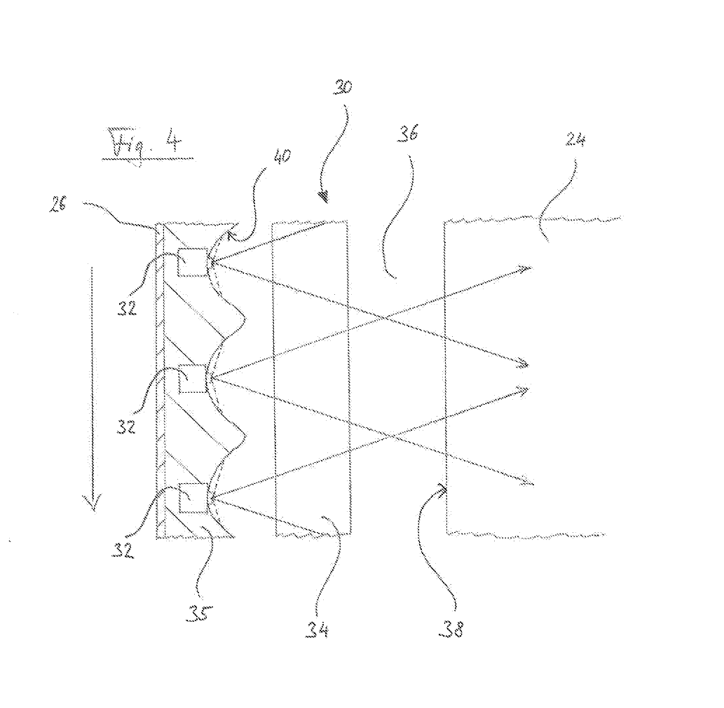

FIG. 4 represents the luminous plate and light source device from FIG. 2, in a sectional view which is orthogonal to FIG. 2;

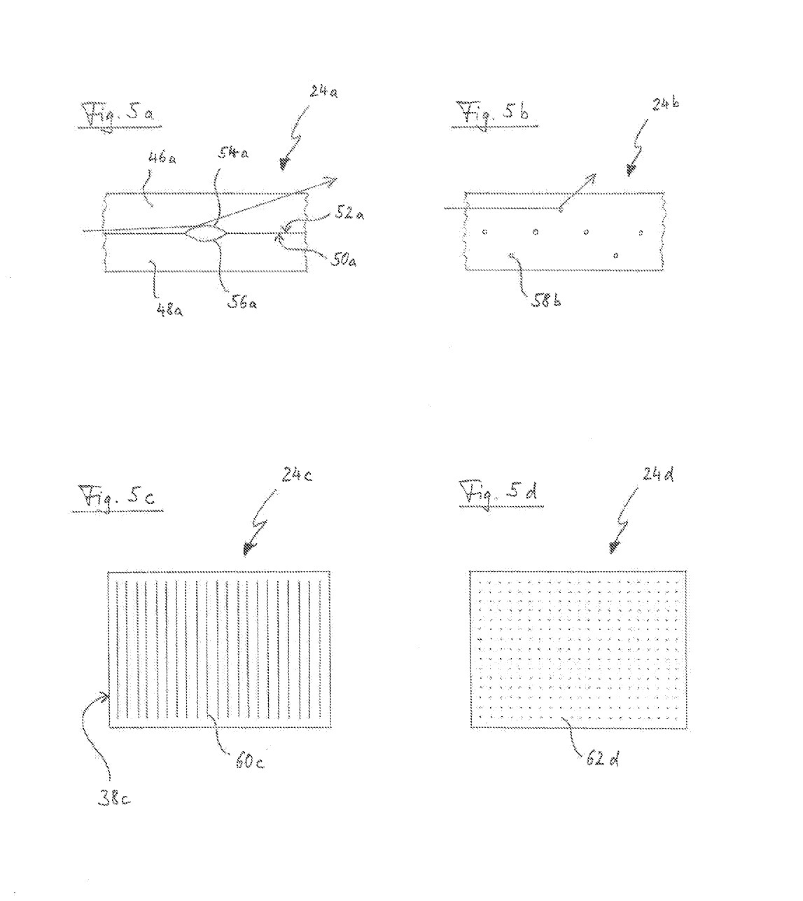

FIG. 5a represents a luminous plate with light-dispersing structures which is formed from a pair of plate elements arranged one on top of the other;

FIG. 5b represents a luminous plate which is formed from a single plate element and has light-dispersing structures at different depths of the material;

FIG. 5c represents a luminous plate with light-dispersing structures in the form of a pattern of lines, in a top view; and

FIG. 5d represents a luminous plate with light-dispersing structures in the form of a pattern of points, in a top view.

Attention is drawn, first of all, to FIG. 1. FIG. 1 shows, diagrammatically, an electrical household appliance 10, for example a refrigerator, freezer, wine-cooler, stove or microwave oven, in a sectional view. Said electrical household appliance 10 comprises an interior 12 which is suitable for keeping foodstuffs or other products for dally use and which is delimited by side walls 14 and 16 and also a rear wall 18. On the front side, the interior 12 has an access aperture 20 with a closable door arrangement 22 through which products can be placed in said interior 12 or removed from the latter. Arranged within the interior 12 is a luminous plate 24 which is carried by a mounting arrangement 26 fastened to the side wall 14 and by a mounting arrangement 28 fastened to the side wall 16. The luminous plate 24 can be used to deposit products which are to be stowed in the interior 12. Obviously, the mounting arrangements shown are to be understood as being merely examples and provision may also be made for fastening the luminous plate 24 in some other way. Obviously, too, further luminous plates with corresponding mounting arrangements may also be provided over the height of the interior 12 in order to make available a number of compartments within the interior as stowing surfaces. Alternatively or in addition, it is also conceivably possible to arrange, behind the walls 14, 15, 18 or in the door arrangement 22, one or more luminous plates which are arranged orthogonally to the luminous plate 24 represented. In this case, the walls 14, 16, 18 or the door arrangement 22 must be of at least partially light-permeable design, such as is the case in, for instance, a perforated microwave lattice or a transparent oven door glass.

FIG. 2 represents the luminous plate 24 on an enlarged scale in a sectional view orthogonal to FIG. 1, and illustrates a light source device 30 which is integrated into the mounting arrangement 26. Obviously, the light source device 30 may, of course, also be mounted in some other way. Said light source device 30 comprises a light-emitting diode 32, a lens 34 and a reflector cavity 36 which is formed by a reflector structure 35 and, in the sectional view shown, is shaped approximately like a concave or parabolic mirror. The light-emitting diode 32 is supplied with current in a manner known to the person skilled in the art, for instance via a circuit board (not represented), and is arranged in the region of the bottom of the reflector cavity 36. The aperture of said reflector cavity 36 faces towards the narrow side 38 of the luminous plate 24 and the walls of said reflector cavity 36 form a reflective surface 40 for light emitted by the light-emitting diode 32. The lens 34 is arranged so as to be completely recessed within the reflector cavity 36 and fills up, substantially completely, the region between opposite sides of the cavity, at a distance from the bottom of the cavity. The ends of the reflector structure 35 which face towards the narrow side 38 of the luminous plate 24 border on said narrow side 38, so that the reflector cavity 36 is closed by said narrow side 38. The reflector cavity 36 also possesses a dear aperture width which approximately corresponds to the thickness of the luminous plate 24.

In the case of the angle of emission of the light-emitting diode 32, which angle is indicated by the broken lines, a portion of the light radiated by said light-emitting diode 32 impinges directly upon the lens 34, and other portions of the light impinge initially upon the reflective surface 40 on which the incident light is initially reflected before it passes to the lens 34. Because of the shape of the reflector cavity 36, even any light which has been reflected back finally reaches the lens 34. The light is then collimated by said lens 34 and subsequently fed into the luminous plate 24 on the narrow side 38. After that, the light fed in is guided within the interior of the luminous plate 24, under which circumstances light rays having a direction of propagation which is not parallel to the flat sides 42 and 44 of the luminous plate 24 pass out of said luminous plate 24, but light rays having a direction of propagation which is parallel, or virtually parallel, to the flat sides 42 and 44 do not initially leave the luminous plate 24 because of total reflections occurring on said flat sides 42 and 44.

The luminous plate 24 may be formed from a light-conducting, at least partially transparent material, for example may be designed as a simple glass plate. The reflector structure 35 forming the reflector cavity 36 is preferably produced from non-metallic material and may be formed by a light-coloured, for instance white, reflector body, for example by an injection-moulded white plastic body. That narrow side of the luminous plate 24 which lies opposite the narrow side 38 and is adjacent to the side wall 16 may additionally be coated with an aluminium film which reflects back the light which is guided within the luminous plate 24.

FIG. 3 illustrates a variant of this arrangement, which variant differs from the arrangement represented in FIG. 2 through the fact that the lens 34 is constructed in one piece with a light-guide body 45 which is arranged between the bottom of the reflector cavity 36 and the lens 34. In this instance, the light-guide body 45 fills up, substantially completely, the region of the reflector cavity 36 between the bottom of said reflector cavity 36 and the lens 34. In this case, light radiated by the light-emitting diode 32 is initially fed into the light-guide body 45. Light which is radiated by the light-emitting diode 32 towards the walls of the cavity is then reflected, substantially by total reflection, internally on the boundary surfaces of the light-guide body 45—instead of on the reflective surface 40—and is kept inside said light-guide body 45 before finally passing out of the light-guide body 45 towards the narrow side 38, if applicable through the lens 34 which is constructed in one piece with said light-guide body 45. In this case, the light-guide body 45 alone would obviously be sufficient to direct the major portion of the light radiated by the light-emitting diode onto the narrow side 38. It would therefore also be possible to dispense with the reflector structure 35 surrounding the light-guide body 45. It is also obvious that the light-guide body 45 in the sectional view shown may also have a shape other than one like a concave or parabolic mirror, for example a trapezium-like shape. Under these circumstances, the light-guide body 45 may be designed, for instance, as a transparent, solid moulded part.

Viewed in the longitudinal extension of the narrow side 38, that is to say in the direction of depth of the drawing in FIG. 2, the reflector cavity 36 is designed, lengthwise, in a trench-like manner, and the lens 34 is constructed as an elongated, cylindrical rod lens. In this case, the configuration of the reflector cavity 36, which configuration is represented in FIG. 2 and is in the shape of a concave or parabolic mirror when viewed in section, may be continued with the same measurements in the direction of depth of the drawing and thereby form a trench-shaped cavity. In this instance, a plurality of light-emitting diodes 32 may be provided, arranged one behind another in the trench longitudinal direction, and may together form an LED strip. In order, in this case, to achieve the most uniform possible distribution of intensity of the light radiated by the light-emitting diodes 32 which are arranged one behind another in a row, it may be advantageous to provide the shape of the bottom of the reflector cavity 36 with an undulatory profile in the trench longitudinal direction. This situation is represented in FIG. 4, which illustrates the light source device 30, together with the luminous plate 24, in a section which is orthogonal to FIG. 2. The arrow which is shown therein indicates the direction of depth of the drawing in FIG. 2. In this instance, troughs of the undulations are further away from the narrow side 38 of the luminous plate 24 than are peaks of the undulations. The light-emitting diodes 32 are arranged in the region of the troughs of the undulations.

In an arrangement which is illustrated according to FIG. 2, it has turned out that about 70% of the light rays emitted by the light-emitting diode and fed into the luminous plate 24 have a direction of propagation which is (virtually) parallel to the flat sides 42 and 44 of said luminous plate 24, and about 30% of the light rays enter said luminous plate 24 at a slight angle to said flat sides 42 and 44. All in all, this makes it possible to achieve an efficiency in which up to about 88% of the output of the light-emitting diode is used and fed into the luminous plate 24.

The possible configurations of the luminous plate 24 which are not represented in any further detail in the preceding figures will be described below with the aid of FIGS. 5a to 5d. In these, components which are identical or which act in an identical manner are provided with the same reference numerals as in the preceding figures, but supplemented by a small letter. Unless otherwise indicated below, attention is drawn to the previous remarks regarding FIGS. 1 to 4 for the purpose of explaining these components.

In order to allow a portion of the light which is fed into the luminous plate 24 and the major portion of which is guided (virtually) parallel to the flat sides 42 and 44 to pass out of said luminous plate 24 in a controlled manner, there may be formed on the inside of said luminous plate 24, at a distance from its outer flat sides 42 and 44, one or more light-dispersing structures which function, so to speak, as points of disruption and the effect of which is that the light impinging upon these points is dispersed, in particular dispersed in a diffuse manner, and thereby caused to pass out of the luminous plate 24. By suitably selected distribution of light-dispersing structures over the luminous plate 24, the light guided within said luminous plate 24 can be dispersed in such a way that the intensity of the light passing out of said luminous plate 24 is as evenly distributed as possible, and the most homogeneous possible illumination of the interior 12 is thereby achieved.

FIG. 5a shows, in cross-section, a luminous plate 24a which is formed by a pair of plate elements 46a and 48a which are arranged one on top of the other. Under these circumstances, said two plate elements 46a and 48a may be coupled to one another, for instance mechanically, for example by riveting or by clamping them together on the narrow sides in an aluminium profile. It is also conceivable, for instance, to bond the plate elements 46a and 48a together or join them to one another by ultrasound welding. In the case of each of the two plate elements 46a and 48a, a light-dispersing structure 54a and 56a is formed on the flat side, 50a and 52a respectively, which faces towards the other plate element in each case. In the exemplary case shown, the light-dispersing structures 54a and 56a are designed as indentations which lie opposite one another and the effect of which is that portions of the light which is guided within the plate elements 46a and 48a are dispersed at these points and are caused to pass out of the luminous plate 24a. Under these circumstances, the indentations may, for instance, be machined into the flat sides, 50a and 52a respectively, by scribing, milling, embossing or engraving, in particular laser engraving.

FIG. 5b shows, in cross-section, a luminous plate 24b which is produced from a single plate element. In this case, said luminous plate 24b has formed a plurality of light-dispensing structures 58b within the depth of its plate material. The point-like light-dispensing structures 58b which are shown here as examples are arranged in different planes along the thickness of the luminous plate 24b, as a result of which uniform dispersion of the light guided within said luminous plate 24b is promoted. In this variant, the light-dispersing structures 58b may be produced, for instance, by three-dimensional laser engraving.

FIGS. 5c and 5d illustrate exemplary patterns of light-dispersing structures, in a top view of the luminous plates which are shown therein. FIG. 5c shows a luminous plate 24c having light-dispersing structures 60c which extend in a line-like manner and which together form a pattern consisting of lines which extend in a parallel manner. In the example shown, the lines extend parallel to the narrow side 38c on which the light is fed into the luminous plate 24c. Under these circumstances, it may be advantageous to reduce the distances between mutually adjacent lines—in a manner different from that represented—with a progressive remoteness from the narrow side 38c, in order to thus counteract the light intensity which becomes lower as the remoteness increases, and to thereby achieve a departure of the light with the most uniform possible distribution of intensity over the luminous plate as a whole. Obviously, in other configurations, the lines which extend in a parallel manner may also have a path which is perpendicular, or even oblique, in relation to the narrow side 38c, instead of one which is parallel to said narrow side 38c.

FIG. 5d, on the other hand, shows a luminous plate 24d having light-dispersing structures 62d which are distributed in a point-like manner and which together form a pattern of points. In the example shown, the points are distributed substantially uniformly over the luminous plate 24d. Obviously, patterns of points of any other desired kinds are, of course, also conceivably possible. In one variant, use may even be made of point-like light-dispersing structures which are so small that they are scarcely perceptible to the human eye.

Finally, it is also conceivable to design any desired combination of features of the variants described in connection with FIGS. 5a to 5d. Thus it is conceivable, for instance, even in the case of a luminous plate formed from a pair of plate elements which are arranged one on top of the other, to form one or more luminous structures within the depth of the particular material of one or both plate elements, it is also conceivably possible, for instance, to combine point-like and line-like light-dispersing structures with one another in any desired manner.

1. An electrical household appliance comprising:
at least one luminous plate which illuminates an interior of the appliance; and
a light source device which feeds light into the luminous plate at least on a first narrow side of said luminous plate, wherein the light source device includes at least one light-emitting diode and lens optics which collect at least a major portion of the light radiated by the light-emitting diode and direct it onto the first narrow side of the luminous plate.

2. The electrical household appliance according to claim 1, wherein the lens optics collimate, when viewed in a sectional plane orthogonal to the longitudinal extension of the first narrow side, the light of the at least one light-emitting diode that passes to said lens optics, and light-dispersing structures are formed in the luminous plate, at a distance from its outer flat sides, in different planes along the thickness of said luminous plate.

3. The electrical household appliance according to claim 1, wherein the lens optics are accommodated in partially or completely recessed manner in a reflector cavity, the aperture of which faces towards the first narrow side of the luminous plate and the walls of which form a reflective surface for light from the light-emitting diode.

4. The electrical household appliance according to claim 3, wherein the lens optics are constructed in one piece with a light-guide body which is arranged between a bottom of the reflector cavity and said lens optics.

5. The electrical household appliance according to claim 4, wherein the light-guide body fills up, substantially completely, the region of the reflector cavity between the bottom of said reflector cavity and the lens optics.

6. The electrical household appliance according to claim 3, wherein the light-emitting diode is disposed in the region of a bottom of the reflector cavity.

7. The electrical household appliance according to claim 3, wherein the lens optics comprise a lens which fills up, substantially completely, the region between opposite sides of the cavity, at a distance from the bottom of said cavity.

8. The electrical household appliance according to claim 3, wherein the reflector cavity is closed by the first narrow side of the luminous plate.

9. The electrical household appliance according to claim 3, wherein the reflector cavity possesses a clear aperture width which is no larger than the thickness of the luminous plate on the narrow side or corresponds to the said thickness of the plate.

10. The electrical household appliance according to claim 3, wherein the reflector cavity is designed, length-wise, in a trench-like manner in the longitudinal extension of the first narrow side, and the lens optics comprise a rod lens which is elongated in the trench longitudinal direction.

11. The electrical household appliance according to claim 3, wherein the light source device includes a plurality of light-emitting diodes arranged one behind another in the trench longitudinal direction, and the bottom of the reflector cavity has an undulatory profile in said trench longitudinal direction.

12. The electrical household appliance according to claim 1, wherein a second narrow side of the luminous plate, which side lies opposite the first narrow side, is constructed merely to reflect light which is guided within the luminous plate.

13. The electrical household appliance according to claim 1, wherein a further light source device is provided on a second narrow side of the luminous plate, which side lies opposite the first narrow side, in order to also feed light into said luminous plate on the second narrow side.

14. The electrical household appliance according to claim 1, wherein one or more light-dispersing structures are formed in the luminous plate at a distance from its outer flat sides.

15. The electrical household appliance according to claim 14, wherein the luminous plate is produced from a single plate element, and one or more light-dispersing structures are formed within the depth of the plate material.

16. The electrical household appliance according to claim 15, wherein at least one light-dispersing structure is formed by laser engraving.

17. The electrical household appliance according to claim 14, wherein the luminous plate is formed by a pair of plate elements which are arranged one on top of the other, and one or more light-dispersing structures are formed on at least one of the two flat sides, which face towards one another, of the plate elements.

18. The electrical household appliance according to claim 17, wherein at least one light-dispersing structure is formed by at least one of scribing, milling, printing, embossing, engraving, or laser engraving.

19. The electrical household appliance according to claim 14, wherein the luminous plate is provided with at least one of:
light-dispersing structures in the form of a pattern of points;
one or more light-dispensing structures in the form of a pattern of lines; and
light-dispensing structures in different planes along the thickness of said illuminous plate.

20. The electrical household appliance according to claim 1, wherein the appliance is one of a refrigerator, a freezer and a stove.

21. (canceled)
